(19) United States
(12) Patent Application Publication
(10) Pub. No.: US 2016/0181677 A1
(43) Pub. Date: Jun. 23, 2016

(54) RADIO FREQUENCY FILTER ASSEMBLY

(71) Applicant: Prism Mircowave, Inc., Coppell, TX (US)

(72) Inventors: Rossiter Christopher, Carrollton, TX (US); Robert Holeman, Allen, TX (US)

(73) Assignee: Prism Microwave, Inc., Coppell, TX (US)

(21) Appl. No.: 14/436,780

(22) PCT Filed: Oct. 18, 2013
(86) PCT No.: PCT/US2013/065697

§ 371 Date: Apr. 17, 2015

Related U.S. Application Data
(60) Provisional application No. 61/716,145, filed on Oct. 19, 2012.

(51) Int. Cl. H01P 1/20; H01P 11/00

(52) U.S. Cl. CPC H01P 1/20; H01P 11/007

(57) ABSTRACT

Disclosed embodiments are related to attachment and sealing methods for an enclosure containing radio frequency (RF) components that may block propagation of RF signals and may also connect portions of the enclosure. In some embodiments, a gasket is used in an RF filter assembly containing multiple cavities which, in operation, are excited by RF energy. Such a gasket may be used to hold a conductive cover to a chassis containing the cavities. As a result, in some embodiments, radio frequency propagation between certain filter cavities or outside the filter may be prevented while reducing, or eliminating, the need for other mechanical fixing methods, such as by screws, solder and/or welds. Advantageously, the number of mounting screws used for mechanical structure may be reduced, and, in some embodiments, eliminated.

### FIELD

Aspects of the invention relate to radio frequency filter assemblies.

### BACKGROUND

Conventional coaxial radio frequency (RF) filter apparatuses generally include a cover which is mounted on the chassis with fastening screws, solder, and/or weld connections. Typically the cover mounting is realized using a large quantity of mounting screws, solder, and/or welds. The quantity of the screws, solder, and/or welds is related to filter characteristics where radio frequency leakage can happen when the cover grounding points defined by the mounting locations are spaced further apart than a specific fraction of the wavelength. At RF frequencies, wavelengths can be on the order of 6 cm, such that screws may be spaced on the order of ¼ inches apart or closer around the entire perimeter defined by walls defining the perimeter of the chassis. Where isolation between cavities inside of the RF filter is desired, walls within the chassis may isolate the cavities from one another and additional screws, solder points, and/or welds may be used with similar spacing along those walls.

### SUMMARY

The described embodiments of the present invention may advantageously provide a radio frequency cavity filter with a reduced number of cover mounting screws required to provide a desired isolation due to radio frequency signal propagation between resonator cavities and/or outside the filter apparatus.

In other aspects, the invention relates to an RF assembly having at least one cavity within a chassis. The cavity may be bounded by walls to which a cover may be attached. The attachment may be formed with a conductive gasket compressed between the chassis and cover. To support such attachment, a first piece of the assembly may have a groove that receives a portion of a second piece of the assembly. For example, the first piece may be a cover and the second piece may be a chassis.

In some embodiments, the gasket may be compressed between the first piece and the second piece within regions of the groove not occupied by the portion of the second piece. Such a compression coupling both mechanically joins the first and second pieces and blocks leakage of RF energy at the interface between those pieces. In some embodiments, the second piece may be a chassis of the assembly and the first piece may be a cover for the assembly.

In certain embodiments, the gasket may be formed of a malleable metal, such as copper, though other appropriate materials are also possible. In some embodiments, the gasket may be at least partially U-shaped such that the gasket fits over the portion of the second piece. Other shapes are also possible.

In some embodiments, first and second pieces of an RF assembly may be attached with a reduced number of mounting screws, solder joints, and/or welds that are spaced by more than 2 inches, on average, along walls that define a perimeter of the assembly and along walls that define separation between cavities. In some embodiments, the assembly may be free of cover mounting screws, solder joints, welds and/or other mechanical fixing mechanisms between the first and second pieces, which may be a cover and a chassis of an RF filter assembly.

In embodiments in which a gasket is used for mechanical attachment, it may reduce the need for walls of the chassis to be wide enough to accommodate screw holes. Accordingly, in some embodiments, the portion of the second piece may have a thickness of 1 mm or less.

Another aspect of the invention relates to a method of manufacture of an RF assembly having at least one cavity within a chassis. The cavity may be bounded by walls within the chassis. The cavity may be covered by compressing a conductive gasket between a first piece and a second piece of the RF assembly.

In some embodiments, the first piece may have a groove with a width. The second piece may have a portion with a first thickness. The first thickness may be less than the groove width. The gasket may comprise a malleable conductor, such as copper, with an uncompressed second thickness that is greater than a difference between the width and the first thickness. The gasket may be placed over the portion of the second piece

It should be appreciated that the foregoing concepts, and additional concepts discussed below, may be arranged in any suitable combination, as the present disclosure is not limited in this respect. The disclosure also should not be limited to the particular constructions of the components as they might be embodied in any number of ways. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of prospective cross-sectional view of an RF assembly;

FIG. 2 is a schematic representation of an exploded cross-sectional view of an RF assembly; and

FIG. 3 is a schematic representation of a cross-sectional view of the RF assembly of FIG. 2 taken along line 3-3.

### DETAILED DESCRIPTION

The inventors have recognized and appreciated that the excessive use of mounting screws, or other mechanical fixing mechanisms, causes elongated assembly process time as well as increased assembly weight and cost in RF assemblies. Therefore, the inventors have recognized that it may be desirable to provide a method for assembling cavity filters quickly and at reduced cost by reducing, or eliminating, the need for mounting screws, solder, and/or welds. By reducing, or eliminating, the need for mounting screws, solder, and/or welds, an RF assembly may exhibit reduced product weight and reduced assembly times. The inventors have also recognized that it may be desirable to improve the RF performance by providing continuous, or at least more closely spaced grounding along the RF path of the assembly. These and other objects may be achieved by a manufacturing method in which the cover grounding to the filter chassis is provided by a compressed gasket, located between the cover and the chassis. The gasket can be in the form of a malleable conductive material. For example, the gasket may be a metal strip or formed metal sheet. Copper and copper alloys may be used to make such a gasket. Though, it should be appreciated that other materials could also be used.

In some embodiments, a gasket can advantageously be formed via a stamping process. As a result, in some embodiments, a gasket may be formed from a single sheet of metal. A gasket may have a thickness on the order of 1 mm or less, 0.5 mm or less, or any other appropriate thickness.

In contrast to a conventional RF assembly, which may have on the order of 100 to 200 fixing screws, the RF filter assembly described below and illustrated in the figures may be assembled with less than 100 fixing screws attaching the cover to the chassis. In some embodiments, less than 40 fixing screws may be used or, in other embodiments, less than 25 or less than 10 or less than 5 fixing screws may be used. It should be understood that any appropriate number of screws might be used. Nonetheless, regardless of whether or not fixing screws are used, the cover may be secured to the chassis of an RF filter assembly around the perimeter. In some embodiments, the cover may also be attached at the walls of at least two RF resonant cavities. A similarly low number of mechanical fixing locations may be used when other types of mechanical fixing, such as solder or welds, are used.

In view of the above, some embodiments may entail fixing screws, solder points, welds, and/or other types of mechanical fixing arranged with an average spacing of more than 2 inches between fixing locations around the perimeter and/or along the tops of walls defining RF cavities within the chassis. In other embodiments, the average spacing between fixing locations may be 3 inches or greater, 5 inches or greater, 8 inches or greater, or any other appropriate spacing.

In other embodiments, fixing screws, solder points, and/or welds are not used to secure the cover to the chassis. As a result, the walls may be thinner than in a conventional design in which fixing screws are used. As an example, the walls may be 1 mm thick or less. Other wall thicknesses are also possible.

As noted above, in some embodiments, all of the walls in the chassis may be thin. However, it is not a requirement that the wall thickness be uniform throughout the chassis. For example, thin walls may be used for interior dividers between cavities and thicker walls may be used at the perimeter of the chassis for mechanical support. In other embodiments, such thin walls may be used throughout, but, may be broadened in a limited number of locations to support a limited number of mechanical fixing locations. In either event, additional weight of a gasket may be offset by less weight from omitted fixing screws in thinner walls such that, overall, an assembly with components held together with an interference fit gasket may be lighter than a conventional assembly.

As described in more detail below with regards to the figures, in some embodiments, when manufacturing an assembly, a gasket may be compressed into a groove located in a first piece and may be positioned between the first piece and a mating surface of a second piece. This may provide an RF seal between the pieces and/or secure the pieces together. In one particular embodiment described below, the groove is formed in a cover of the assembly and a wall of a chassis is inserted into the groove. However, it should be understood that the groove may be constructed and arranged within any two mating pieces of the assembly and a gasket may be inserted therein to provide the desired RF seal and/or secure the pieces together. Therefore, the disclosure should be interpreted generally as forming an RF seal and/or attachment between any two pieces and should not be limited to only the embodiments described below and picked and features.

Turning now to the figures, one non-limiting embodiment is described in more detail.

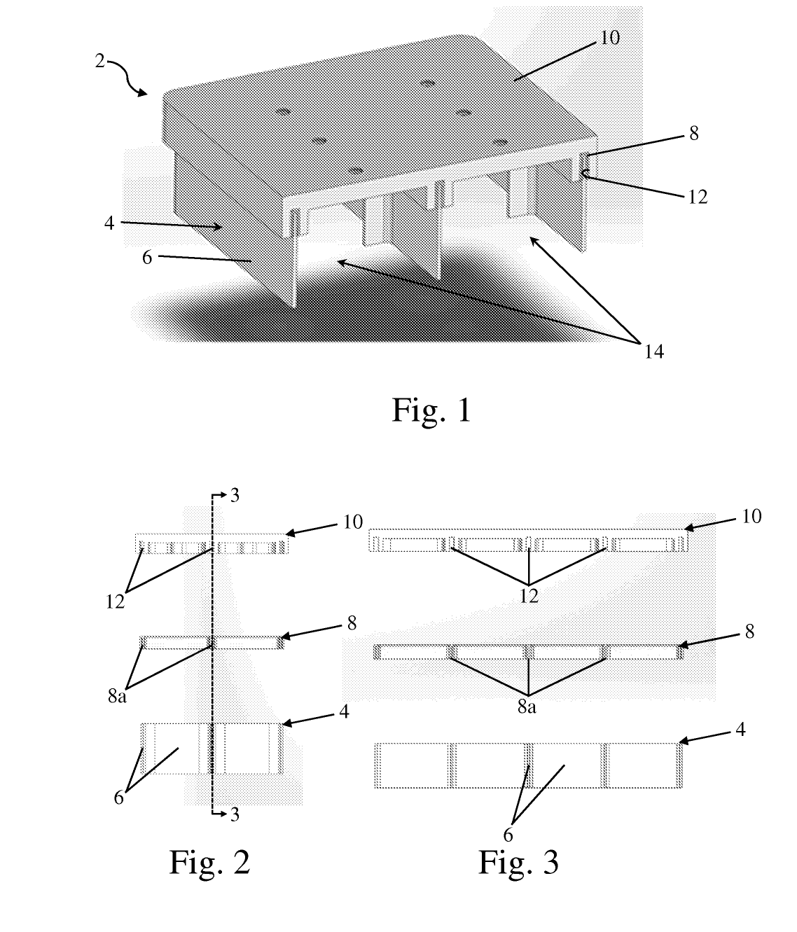

As shown in FIGS. 1-3, in one embodiment, an assembly 2 includes: a cover 10; a malleable conductive gasket 8; and a chassis 4 including filter housing walls 6. The chassis 4 includes both external and internal walls 6. The walls 6 located on the interior of the chassis 4 may correspond to dividing walls located between two or more separate cavities 14 within the chassis 4. The cover 10 includes one or more grooves 12 constructed and arranged on a bottom surface thereof. The one or more grooves 12 extends along a perimeter of the cover and may also be arranged on an interior surface of the cover. For example, the one or more grooves 12 may be constructed and arranged to mate with the interior and/or exterior walls 6 of the chassis 4. As depicted in the figures, the thickness of the walls 6 is less than a width of the one or more grooves 12. The gasket 8 is constructed and arranged to mate with the one or more grooves 12 such that it may be compressed and/or deformed between the mating portions of the walls 6 and the groove 12 of the cover 10 to form an RF seal and/or attachment. Further, the portion of gasket 8 located between the walls 6 and the one or more grooves 12 may be solid as illustrated in the figures.

As also shown in the figures, the gasket 8 may be shaped such that it complements a shape of the groove 12 and/or the walls 6. For example, as depicted in the figures the gasket 8 is a solid gasket that includes a portion 8a stamped as a U-shaped strip that is fitted over the top of the walls 6 and press fit into the groove 12. It should be understood that other geometries are also possible. Further, the gasket may be sized such that it substantially fills a space between the walls 6 and the groove 12. However, it should be understood that some gaps between the groove 12, gasket 8, and/or walls 6 may exist. In one specific embodiment, an uncompressed thickness of the gasket material located between the walls and the groove 12 may be equal to or greater than a difference between a width of the groove 12 and a thickness of the walls 6. While this may be embodied in any number of ways, as illustrated in the figures, the deformed gasket material may be provided on either side of the walls 6 and is compressed against the surrounding surfaces of the grooves 12.

After appropriately arranging the various components, a sufficient pressure is applied to the cover and/or chassis to deform the gasket 8 into the groove 12 to provide the desired RF path grounding and/or mechanical attachment of the cover to the chassis. When the cover is pressed onto the wall, the gasket may be partially deformed to create an interference fit between the walls of the chassis and the groove within the cover. In this way, the cover may be electrically coupled to the chassis, which in turn may be grounded. Depending on the embodiment, any gaps located between the cover and chassis may be filled with the gasket which may help to reduce RF leakage. In addition, mechanical attachment of the cover may be provided by the gasket compressed between the cover and chassis within the groove.

In some embodiments, the above-noted mechanical attachment is provided by plastically deforming the gasket in addition to any residual elastic deformation of the gasket to form an interference fit between the cover and chassis. Without wishing to be bound by theory, in some embodiments, the resulting interference fit due to the plastic deformation of the gasket may be used to provide a fixed as compared to a removable mechanical attachment of the cover to the chassis. A cover with a gasket as described herein may be removed by application of sufficient force, but might nonetheless be regarded as “fixed” or “permanent” because removal of the cover may degrade the seal or otherwise require steps outside of normal operation to remove and replace the cover.

Without wishing to be bound by any particular theory, in some embodiments, the gasket comprises a material that has a lower hardness, a lower yield strength, and/or greater ductility as compared to the material of the cover and/or chassis to facilitate deformation of the gasket to form the interference fit. Alternatively, or in addition to the above, the gasket may be shaped and configured to plastically deform relative to the cover and/or chassis. For example, a gasket might be made from the same material as the cover and/or chassis, but have a thickness substantially less than that of the cover and/or chassis. In such an embodiment, the thickness and/or shape of the gasket is selected to promote plastic deformation of the gasket relative to the cover and/or chassis. While plastic deformation of the gasket has been described above, it should be understood that in some embodiments the gasket, cover, and/or chassis may be configured to form the interference fit by substantially only elastic deformation of one or more of the above components.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are to be regarded as exemplary rather than limiting examples.

What is claimed is:

1. A radio frequency filter assembly comprising:
a first piece including a groove;
a second piece including a portion located in the groove;
a deformed conductive material substantially filling a space between the groove and the portion of the second piece located in the groove.

2. The radio frequency filter assembly of claim 1, wherein the deformed material comprises a conductive gasket that substantially fills the space between the groove and the portion of the second piece.

3. The radio frequency filter assembly of claim 2, wherein the groove has a first width, the portion of the second piece has a first thickness, and the gasket has a second uncompressed thickness when not located between the groove and the portion of the second piece, wherein the second uncompressed thickness is greater than a difference between the first width of the groove and the first thickness of the portion of the second piece.

4. The radio frequency filter assembly of claim 2, wherein the gasket is solid.

5. The radio frequency filter assembly of claim 2, wherein the gasket comprises a U-shape.

6. The radio frequency filter assembly of claim 1, wherein the first piece comprises a cover and the second piece comprises a chassis.

7. The radio frequency filter assembly of claim 1, wherein the deformed conductive material provides a radio frequency seal between the first piece and the second piece.

8. The radio frequency filter assembly of claim 7, wherein the deformed conductive material provides an interference fit to attach the first piece to the second piece.

9. The radio frequency filter assembly of claim 1, wherein the deformed conductive material is elastically deformed.

10. The radio frequency filter assembly of claim 9, wherein the deformed conductive material is plastically deformed.

11. The radio frequency filter assembly of claim 1, further comprising a plurality of mechanical fixing mechanisms additionally fixing the first piece to the second piece, wherein the mechanical fixing mechanisms are spaced, on average across the filter assembly, by 2 inches or more.

12. The radio frequency assembly of claim 1, wherein:
the second piece comprises a chassis having a plurality of cavities bounded by walls and the portion located in the groove comprises upper edges of the walls.

13. A method for assembling a radio frequency filter assembly, the method comprising:
deforming a conductive material between a groove of a first piece and a portion of a second piece located in the groove, wherein the deformed conductive material substantially fills the space between the groove and the portion of the second piece located in the groove.

14. The method of claim 13, wherein deforming the conductive material comprises deforming a conductive gasket to substantially fill the space between the groove and the portion of the second piece.

15. The method of claim 14, wherein the groove has a first width, the portion of the second piece has a first thickness, and the gasket has a second uncompressed thickness prior to deformation, wherein the second uncompressed thickness is less than a difference between the first width of the groove and the first thickness of the portion of the second piece.

16. The method of claim 14, wherein the gasket is solid.

17. The method of claim 14, wherein the gasket comprises a U-shape.

18. The method of claim 13, wherein the first piece comprises a cover and the second piece comprises a chassis.

19. The method of claim 13, wherein the deformed conductive material provides a radio frequency seal between the first piece and the second piece.

20. The method of claim 19, wherein the deformed conductive material provides an interference fit to attach the first piece to the second piece.

21. The method of claim 13, wherein deforming comprises elastically deforming the conductive material.

22. The method of claim 21, wherein deforming comprises plastically deforming the conductive material.
